(19) United States
(12) Patent Application Publication
(10) Pub. No.: US 2012/0067188 A1
(43) Pub. Date: Mar. 22, 2012

(54) BRUSH CUTTER

(76) Inventors: Gilles Denis, Phillipsburg (CA); Laurent Denis, Roxton Falls (CA)

(21) Appl. No.: 13/322,525

(22) PCT Filed: May 28, 2010
(86) PCT No.: PCT/CA10/00809

§ 371 Date: Nov. 25, 2011

Related U.S. Application Data
(60) Provisional application No. 61/217,369, filed on May 28, 2009.

(51) Int. Cl. B26D 1/12

(52) U.S. Cl. 83/665

(57) ABSTRACT

A rotary cutter for a brush cutter. The cutter has a rotatable cylindrical drum with a plurality of flat, annular, collars mounted on the drum. The collars are fastened to the drum by their inner circular edge, are equally spaced apart on the drum, and extend transverse to the rotational axis of the drum. A cutting tooth mounting block is mounted between each adjacent pair of collars, the block located at the outer edge of the collars and spaced above the surface of the drum to provide a gap for passing chips and residue. The mounting block carries a detachable cutting tooth, the tooth extending forwardly generally tangentially from the block and terminating in a cutting edge above the collars.

### BACKGROUND OF THE INVENTION

1. Technical Field

This invention relates to a rotary cutter for a brush cutter. The invention is more particularly directed toward a rotary cutter of the type using a cylindrical drum that carries detachable cutting teeth and is rotatable about its longitudinal axis to cut brush with the teeth.

2. Background Art

Rotary cutters for brush cutters, having a cylindrical drum with cutting teeth mounted directly on the surface of the drum, are known. The cutting teeth are usually mounted on the drum through the use of tooth mounting blocks fixed to the drum surface. The teeth are usually detachably mounted on the front of the mounting blocks with the cutting portion of the tooth angled upwardly and forwardly.

The brush cutters operate in rough terrain and often encounter rocks which can cause damage to the teeth and to the mounting blocks on the drum. The teeth, at least, therefore have to be easily replaceable and should be mounted in a manner where they are at least partly protected from damage. It is known to provide rotary cutters having guard members, normally in the form of collars, extending about the circular periphery of the drum. The collars extend radially out from the drum surface a sufficient distance to protect at least the base of the teeth and the mounting blocks, which are mounted on the cylindrical surface of the drum adjacent the collars, from damage.

The collars do protect the blocks and teeth. However, with the blocks and teeth located on the surface of the drum, between the collars, maintenance and servicing is difficult. Dispersing the cut material from between the collars is also a problem with the mounting blocks in the way. In addition, with the teeth being angled upwardly and forwardly to project past the collars, the teeth are shortened each time they are sharpened and the teeth become less efficient in picking up material to be cut and chipped. With the teeth being angled upwardly and forwardly, the teeth are more liable to be damaged by bending if striking an object.

### SUMMARY OF THE INVENTION

It is the purpose of the present invention to provide a rotary cutter for a brush cutter which is strong, easily maintained and repaired, and more efficient in cutting and dispersing chips, while still being protective of the cutting teeth, and the mounting blocks for the teeth, to extend their life and thus reduce costs.

The rotary cutter of the present invention employs protective collars on a cylindrical drum with the mounting blocks for the teeth mounted on the peripheral outer portion of the collars, each block mounted to, and between, two adjacent collars. The mounting of each block to, and between, two adjacent collars provides a rigid structure better able to withstand damage. The blocks are located on the collars with most of the block just below the peripheral outer edge of the collars to protect them from damage. The teeth on the mounting blocks are, at least in part, located slightly above the collars to extend in a generally tangential direction so that the cutting edge remains in an optimal operating position even after repeated sharpening.

The teeth and mounting blocks, located at the outer peripheral portion of the collars, are positioned to be easily serviced and repaired. With the blocks mounted to the collars well above the surface of the drum, a gap is formed between each mounting block and the surface of the drum, between the adjacent collars supporting the block, allowing efficient chip dispersal through the gap. To further assist dispersal of the chips, the collars can be shaped to provide clearance below and in front of the teeth to promote efficient chip dispersal and to further facilitate servicing of the teeth. With the teeth extending generally tangentially, and with there being good clearance in front and below the front of the teeth, the teeth are well suited for efficiently picking up and chipping brush as the drum rotates, and for being able to continue doing so even after repeated sharpening.

The tangential extending portion of the teeth are aligned with the mounting block in a lengthwise direction of the block so that cutting forces are transmitted to the block in compression rather than in shear or bending making the rotary cutter much stronger. The cutter is also stronger since each adjacent collar pair has at least one block mounted to, and between, them and preferably two diametrically opposed blocks mounted to, and between, the collars. Each collar of the pair also pairs with another adjacent collar and is joined to it with at least one and preferably two diametrically opposed blocks which blocks are circumferentially offset with respect to the first two blocks on the first pair of collars. This interconnection of the collars with the blocks about the cylindrical profile of the cutter strengthens the cutter structure. It also allows the radial width of the collars to be increased to allow a greater material dispersal gap to be provided under the mounting blocks without weakening the cutter.

The invention is particularly directed to a rotary cutter for a brush cutter that mounts each cutting tooth mounting block to, and between, two adjacent collars at the outer peripheral portion of the collars. The collars, and the drum they are mounted on, are preferably dimensioned to have the diameter of the collars about twice the diameter of the drum they are mounted on to provide the optimum size of cutter for efficient cutting while also providing a relatively large chip dispersal gap between each block and the drum.

The invention is further directed toward a rotary cutter for a brush cutter where the collars are provided with a first set of cut-outs in their periphery just in front of the mounting blocks to improve chip dispersal. The collars are provided with a second set of cut-outs extending rearwardly from the first set of cut-outs to receive at least a portion of the mounting blocks. The second set of cut-outs provide an abutment for the blocks adjacent the outer edge of the collars. This results in cutting forces being transferred directly from the teeth through the blocks and against the collars in compression rather than shear thereby strengthing the unit.

The invention is further particularly directed toward a rotary cutter for a brush cutter having at least the cutting portion of the cutting tooth extending generally tangentially to a radius line from the axis of rotation of the drum to the front of the mounting block. The cutting portion of the tooth is also aligned with the block to transmit cutting forces directly to the block in compression.

The invention is further particularly directed toward a rotary cutter provided with a plurality of collars on the surface of a rotary cylindrical drum, the collars equally spaced apart and extending transverse to the axis of rotation of the drum. Each adjacent pair of collars has two opposed mounting blocks mounted on, and between, the collars in the peripheral outer portion of the collars. Each collar has two additional opposed mounting blocks mounted on and between it and another adjacent collar, the two additional opposed mounting blocks circumferentially offset from the first two mounting blocks. The two additional blocks on the first collar can be circumferentially offset in one direction from the first blocks and the two additional blocks on the second collar can be circumferentially offset in the opposite direction from the first blocks.

### DESCRIPTION OF SEVERAL VIEWS OF THE DRAWINGS

FIG. 1 is a perspective view of the rotary cutter of the present invention partially disassembled;

FIG. 2 is a front detail view of a portion of the rotary cutter;

FIG. 3 is an end view of FIG. 2;

FIG. 4 is a perspective view of a mounting block;

FIG. 5 is a front view of the mounting block;

FIG. 6 is a side view of the mounting block;

FIG. 7 is a perspective view of the cutting tooth;

FIG. 8 is a front view of the cutting tooth;

FIG. 9 is a side view of the cutting tooth;

FIG. 10 is side view of the assembled cutting tooth and mounting block;

FIG. 11 is a side view of another embodiment of the rotary cutter;

FIG. 12 is a side view of the mounting block used in the embodiment shown in FIG. 11;

FIG. 13 is a front view of the mounting block, showing it mounted on the collars;

FIG. 14 is a perspective view of the cutting tooth used in the embodiment shown in FIG. 11;

FIG. 15 is a view of the cutting tooth; and

FIG. 16 is a perspective view of the assembled mounting block and cutting tooth.

### DETAILED DESCRIPTION OF THE INVENTION

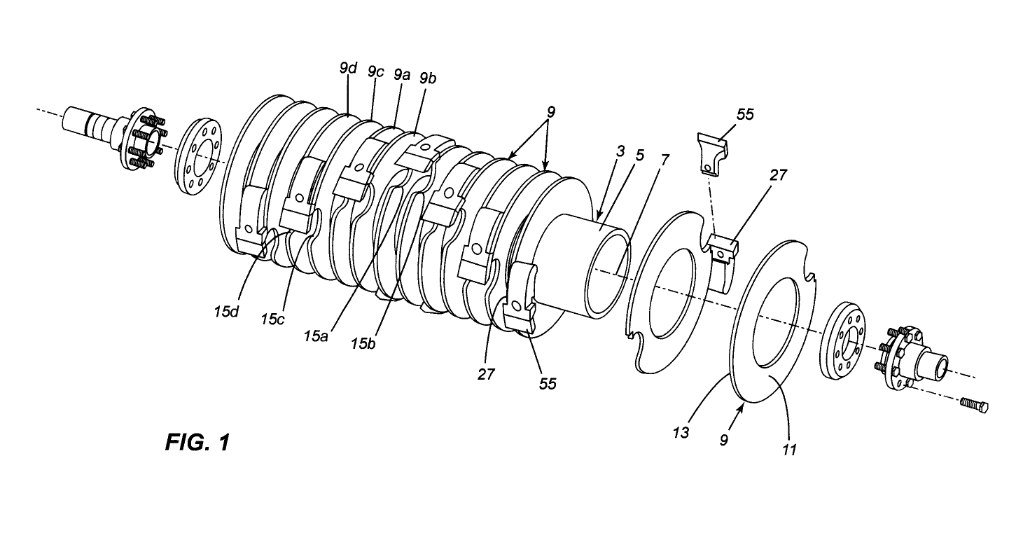

The rotary cutter 1, as shown in FIGS. 1 to 3, has a cylindrical drum 3 with an outer surface 5. The drum 3 is rotatably mounted at its ends. The drum can be mounted on the front of a vehicle or on the end of a boom carried by a vehicle. Means, well known and not described, are connected to the drum 3 at one end to rotate it about its longitudinal axis 7.

Flat collars 9, with a circular inner edge 11 and an outer edge 13 that is circular-like, are fastened to the outer surface 5 of the drum 3. The circular inner edge 11 is just slightly larger than the diameter of the drum 3 and the collars are welded to the drum surface 5 at their inner edge 11. The collars 9 normally extend transverse to the longitudinal axis 7 of the drum 3, and are equally spaced-apart along the length of the drum. The longest dimension of the each collar, along a straight line passing through the center of its circular inner edge 11, is about double the diameter of the inner edge 11 and thus about double the diameter of the drum 3. The drum 3 can, for example, be about nine and a half inches in diameter, while the longest dimension of the collar, along a straight line through the center of its inner edge can be about eighteen inches. The collars are normally spaced apart about two inches on the drum and are about one-half inch thick.

Each collar 9, as shown in FIG. 3, has a first cut-out 15 extending about half-way into the collar from its outer peripheral edge 13. The cut-out 15 has a generally part-circular shape. The cut-outs 15 in each adjacent pair of collars are aligned when viewed from either end of the drum 3. Each succeeding collar will have a similar cut-out 15 circumferentially offset from the first cut-outs 15 in the first adjacent collar pair. This cut-out 15 will be aligned with a similar cut-out in the preceeding collar. The offset between cut-out pairs can be about 60° but can range between 45° and 90°.

Each collar 9, except for the first and last collars, will preferably have two generally diametrically opposed first cut-outs 15. Each cut-out 15 has a leading side 17 and a trailing side 19, the leading side being the side leading on rotation of the drum. One cut-out 15 in each collar will be used with a similar cut-out in a second collar adjacent one side of the collar and the second opposed cut-out in the collar will be used with a similar cut-out in a third collar adjacent the other side of the collar. Thus collar 9A in FIG. 1 has a first cut-out 15A that co-operates with a first cut-out 15B on an adjacent collar 15B on one side of collar 9A. Collar 9A also has a second cut-out, not shown but generally diametrically opposite first cut-out 15A, that co-operates with the second cut-out, not shown, on adjacent collar 9C on the other side of collar 9A. The second cut-out on collar 9C is generally diametrically opposite the first cut-out 15C on collar 9C. The aligned cut-outs on any collar pair are circumferentially offset from the aligned cut-outs on adjacent collar pairs. Thus aligned cut-outs 15A, 15B on the adjacent pair of collars 9A, 9B are circumferentially offset from the aligned cut-out pair 15C, 15D on the adjacent pair of collars 9C, 9D. The cut-outs 15 are used for chip and material dispersal generated during operation of the cutter.

Each collar 9, as shown in FIG. 3, with two cut-outs 15, is preferably formed with a peripheral outer edge portion 13a that, at each cut-out 15 on the leading side 17 of the cut-out, is closer to the drum 3 than it is on the trailing side 19 of the cut-out. Thus the radius r1 of the outer edge portion 13a at the leading side 17 of one cut-out 15 is less than the radius R1 at the trailing side 19 of the other cut-out 15. The peripheral edge portions 13a have a slightly helical shape between cut-outs 15. The helical shape of the collar edge portions 13a preferably extends between the cut-outs 15 but could be shortened if desired to extend only about halfway, or even slightly less, between the leading and trailing sides of adjacent cut-outs. The reduced radius of the collar at the leading side of the cut-outs 15 provides clearance for the cutting tooth as will become apparent.

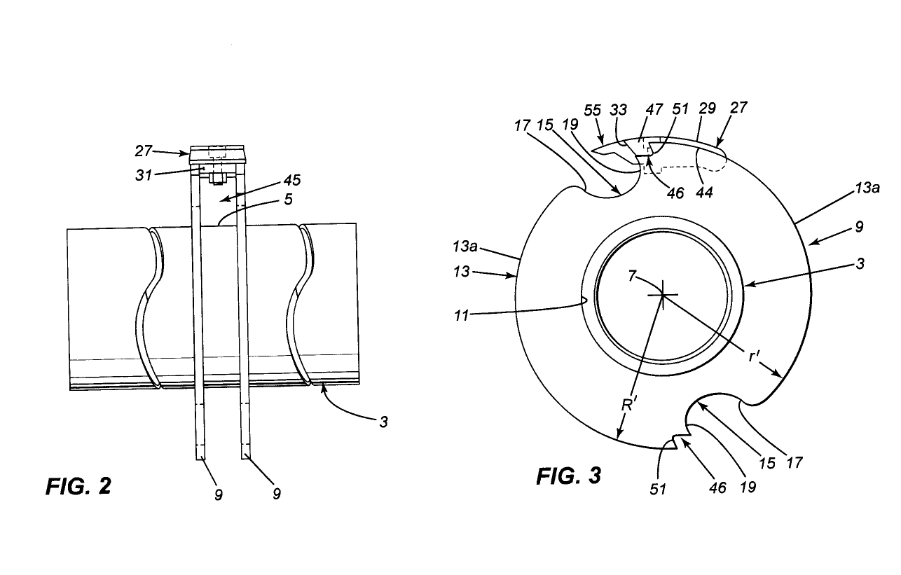

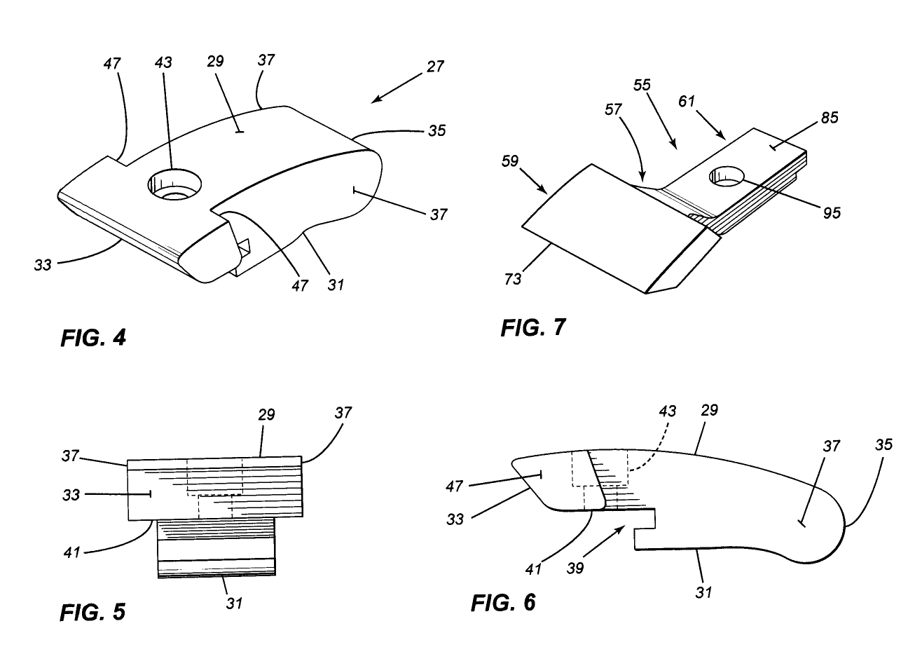

A mounting block 27 is mounted on and between each adjacent pair of collars 9 on the drum 3 as shown in detail in FIGS. 2 and 3. Each mounting block 27, as shown in FIGS. 3-6, has a generally parallelepiped shape with a top surface 29 and a bottom surface 31 joined by front 33, rear 35 and side surfaces 37. The top surface 29 can be slightly convex, with generally about the same curvature as the curvature of the outer peripheral edge 13 of the collars 9. The bottom, front portion of the block 27 is undercut as shown at 39 to provide a flat, bottom, mounting surface 41 above the bottom surface 31 of the block. The front surface 33 is preferably angled slightly rearwardly although it can also extend radially from the axis of the drum. A mounting hole 43 extends through the block 27 between the top surface 29 and the mounting surface 41.

Each mounting block 27 is sized to fit snugly between an adjacent pair of collars 9 and is located in upper peripheral portion of the collars. At least an upper portion of the block 27 is positioned at least slightly above the collars 9, above the outer edges 13, as seen in FIG. 3. The block 27 is welded to the outer edges 13 of the adjacent collars 9 with the front surface 33 of the block located adjacent the trailing side 19 of the cut-out 15 and with the top surface 29 generally parallel to the outer edges 13a of the collars 9. The block 27 is long enough to have the welds 44 long enough to normally absorb the cutting forces acting in shear on the welds. When the block 27 is mounted between the collars 9, its bottom surface 31 is spaced well above the outer surface 5 of the drum 3 forming a relatively large chip dispersal gap 45 as shown in FIG. 2.

Preferably, at least a portion of the mounting block 27 is directly supported by the adjacent collars 9 associated with the block. Each collar 9 is provided with a second, smaller cut-out 46 adjacent the trailing side 19 of each first cut-out 15 in the collars. Each block 27 can be provided with short, lateral extending arms 47 on the top, front portion of the block to support the block on the collars 9. The arms 47 are shaped to fit snugly onto the second cut-outs 46 when the block 27 is positioned between the collars 9 with the arms 47 abutting the trailing side 51 of the second cut-outs 46. When the block 27 is welded in place to the collars 9, the arms 47 are also welded to the collars in the area of the second cut-outs 46. The arms 47 transmit cutting forces to the back sides 51 of the cut-outs 46, and thus to the collars 9, directly by compression.

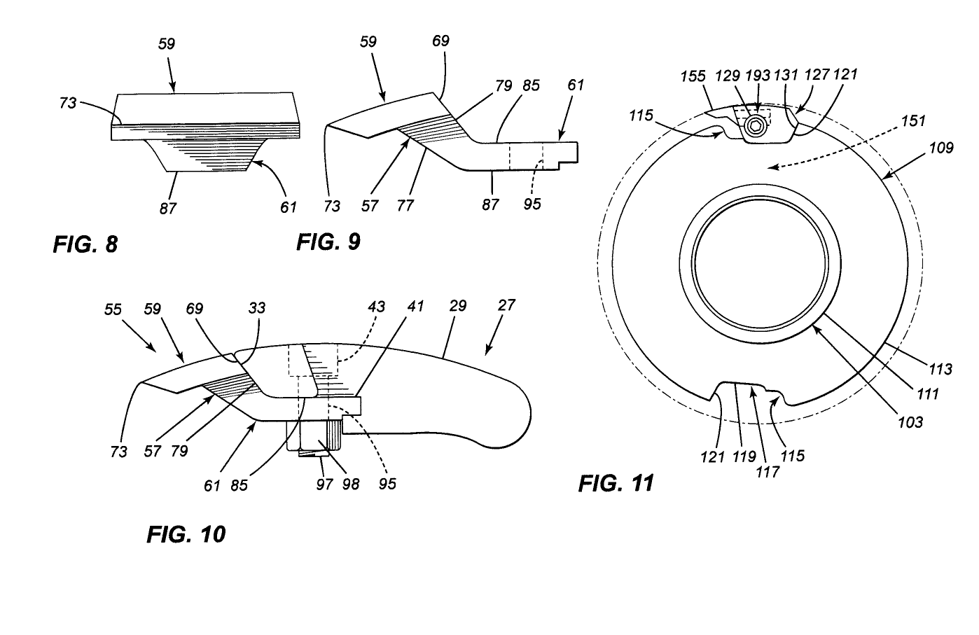

A cutting tooth 55 is mounted on each mounting block 27. The cutting tooth 55, as shown in FIGS. 7-9, comprises a support portion 57, a cutting portion 59 and a mounting portion 61. The cutting tooth 55 is an integral member, preferably forged. The cutting portion 59 extends forwardly from the top of the front surface 77 of the support portion 57 terminating in a cutting edge 73. The support portion 57 is relatively short in length compared to the cutting portion 59, about half its length. The mounting portion 61 extends rearwardly from the support portion 57 and is below the cutting portion 59. A bolt hole 95 extends between the top and bottom surfaces 85, 87 of the mounting portion 61 about midway in its length.

The cutting tooth 55 is positioned on the mounting block 27 with the back surfaces 69, 79 of the cutting portion 59 and the support portion 57 respectively abutting the front surface 33 of the block 27 and with the top surface 85 of the mounting portion 61 abutting the bottom surface 41 of the undercut 39 of the block 27 as shown in FIG. 10. In this position, the bolt holes 43, 95 in the block 27 and the mounting portion 61 of the tooth, respectively, are aligned. A bolt 97 is then passed through the aligned holes 43, 95 and a nut 98 is used on the bolt 97 to securely, detachably, fasten the tooth 55 to the mounting block 27 as shown in FIG. 10.

When the tooth 55 is mounted onto the mounting block 27, the cutting portion 59 of the tooth is generally aligned with the top portion of the mounting block 27 and extends generally tangentially forwardly from a radius line extending from the axis 7 of the drum 3 to the front of the block 27. The cutting portion 59 could be curved slightly to have its upper surface lie on or close to the imaginary circle generated by the cutting edge of the tooth during rotation of the cutter. Cutting forces are primarily transmitted directly to the block as compression forces from the rear 67 of the cutting portion 59 abutting directly on the front 33 of the block 27. These forces are then transmitted to the collars 9, from the arms 47, as compression forces and from the block 27 as shear forces through the welds 44. The position of the cutting portion 59 allows the tooth to be sharpened without substantially changing the distance of the cutting edge 73 from the axis 7 of rotation of the cutter.

Since the peripheral edges 13 of the collars 9 are closer to the drum 5 at the leading edge 17 of the first cut-out 15 than they are at the trailing edge 19, the cutting portion 59 of the tooth 55 is above the peripheral edge 13 of the collars at the cut-out 15, providing clearance for a substantial cut as shown in FIG. 3. The clearance can be approximately one inch. The chips cut are eliminated through the first cut-outs 15 in the collars 9 and through the gap 45 between the mounting block 27 and the drum 3.

In another embodiment of the invention, as shown in FIGS. 11-14, the collars 109 on the drum 103 can be annular with circular inner and outer edges 111, 113 as seen in FIG. 11. The collars 109, except for the first and second collars, have a pair of opposed first cut-outs 115 extending inwardly from the outer edge 113 of the collars and a second cut-out 117, trailing each first cut-out 115, extending inwardly from the outer edge 113 adjacent the first cut-out 115. In this embodiment, the first cut-out 115 is shallower than the second cut-out 117 and part circular while the second cut-out 117 is generally elongated with a straight bottom portion 119 and a straight end 121 opposite the first cut-out 115.

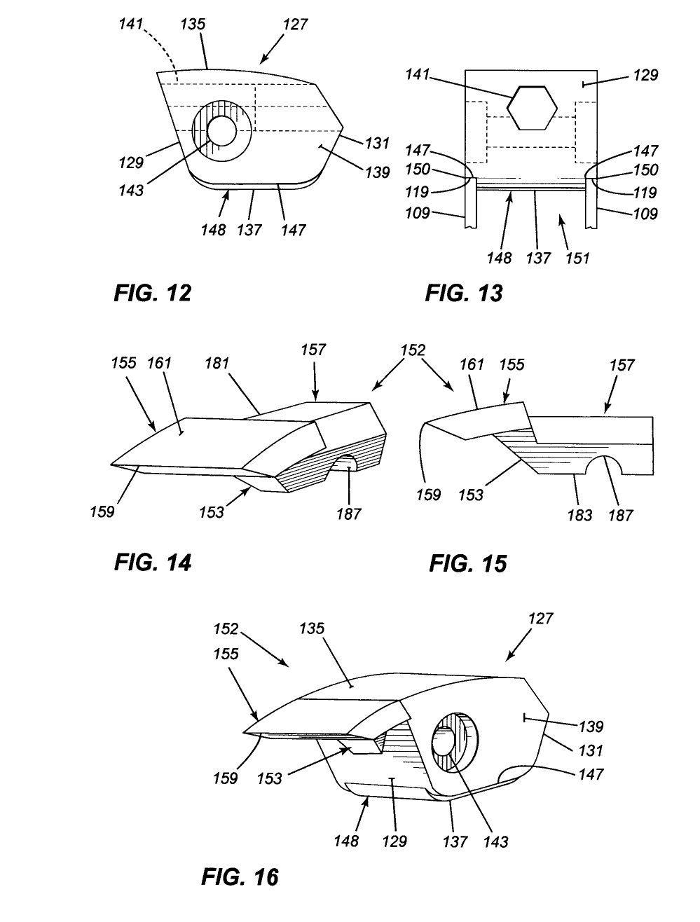

In this embodiment, the mounting block 127, a generally regular, parallelepiped, as shown in FIGS. 12 and 14, has a front surface 129, a back surface 131, top and bottom surfaces 135, 137 extending between the front and back surfaces 129, 131, and side surfaces 139. The top surface 135 is slightly convex between its ends. The front surface 129 is angled slightly rearwardly. The block 127 is slightly longer than its width, and its height is about equal to its width. A mounting hole 141 extends rearwardly into the block from the front surface 129. The hole 141 has a cross-sectional area matching the cross-sectional area of the mounting portion of the cutting tooth as will be described. A locking opening 143 extends across the block between its sides 139. The locking opening 143 intercepts part of the mounting hole 141 in passing through the block. The sides 139 of the block 127, adjacent the bottom surface 137, are stepped, as shown at 145, to form mounting shoulders 147 on both sides of the block, the mounting shoulders 147 parallel to the bottom surface 137 of the block. The steps 145 define a bottom portion 148 of the block that has a width equal to the width between two adjacent collars 109.

The mounting block 127 is mounted between two adjacent collars 109, as shown in FIGS. 11 and 13. The bottom portion 148 of the block is inserted between the collars until the mounting shoulders 147 rest on the bottom straight edges 119 of the second cut-outs 117 in the collars. The rear 131 of the mounting block abuts the trailing end 121 of the second cut-outs 117 as shown in FIG. 11. The mounting block 127 is then welded to the collars with welds 150 along the edges of sides 119, 121 of the second cut-outs 117. In this position, the mounting block 127 is positioned well above the surface 105 of the drum 103 forming a relatively large chip dispersal gap 151 between the mounting block 127 and the surface 105 of the drum.

The cutting tooth 152, shown in FIGS. 14 and 15, and used with the mounting block 127, comprises a support portion 153, a cutting portion 155 mounted on and extending forwardly from the top of the support portion 153, and a mounting portion 157 extending rearwardly from the support portion 153, the mounting portion below the cutting portion 155. The tooth is an integral member, preferably made by forging. The cutting portion 155 terminates in a cutting edge 159. The top surface 161 of the cutting portion is preferably curved to lie in the imaginary circle generated by the cutting edge 159 when the tooth is installed and operational. The support portion 153 is in the shape of a tapered block. The mounting portion 157 extends rearwardly from both the rear of the cutting portion 155 and the rear of the support portion 153. The mounting portion 157 is in the form of a shank 183 having a cross-sectional shape and size matching the cross-sectional shape and size of the mounting hole 141 in the block 127. The cross-sectional shape is shown as a hexagon, but the mounting portion can have other, non-circular, cross-sectional shapes such as a circle with a radial rib, a square, or an octagon, by way of example. The shank 183 has locking means which can be in the form of a half cylinder 187 cut into the shank 183 from its bottom surface, to extend transversely across the shank.

With the mounting block 127 fixed to the collars 109, the tooth 152 is detachably mounted in the mounting block 127 by sliding the mounting portion 157 into the mounting hole 141 in the block until the rear of the cutting portion 155 abuts against the front surface 129 of the block as shown in FIG. 11. In this position the top surface 161 of the cutting portion 155 is aligned with the top surface 135 of the block and the cutting portion 155 is aligned with, and abutting, the top portion of the block 127. The locking opening 187 in the tooth is aligned with the locking opening 143 in the block. A bolt 191 is passed through the aligned locking openings 143, 187 and a nut locks the bolt in place, as shown in FIG. 11, locking the tooth 141 to the mounting block 127 in the desired position. In this position the cutting portion 155 is well spaced above the outer edge 113 of the collars 109 as shown in FIG. 11. The cutting force from the cutting portion of the tooth is directed directly as a compression force against the front face 129 of the block and through the block, as a compression force, to the trailing end 121 of the cut-out 117 to the collar. The mounting block 127 and the welds 150 are made long enough to resist any the shear forces. The chips and material cut by the teeth are dispersed through the cut-outs 115, and through the gap 151.

If desired, the cutting portion in all embodiments can be slightly bevelled from the top to slightly lower the cutting edge to provide a slight rake or clearance of a few degrees to the top surface of the tooth to make cutting easier. The cutting portion can be straight or slightly curved. If straight, the position of the cutting edge will slightly change each time the tooth is sharpened but not to any significant extent. While two different cutting teeth have been described, other cutting teeth can be employed. The cutting edge of the tooth, in all embodiments, is slightly wider than the distance between the outer sides of the adjacent collars the tooth is mounted on. In all the embodiments, at least fifty percent of the mounting block is mounted below the outer edge of the collars to provide protection for the block and for the portion of the tooth that it carries.

I claim:

1. A rotary cutter for a brush cutter; the cutter having a rotatable, cylindrical drum (3); flat, annular-like, collars (9) having inner (11) and outer (13) edges, the collars (9) fastened to the outer surface (5) of the drum (3) by their inner (11) edge, the collars equally spaced-apart in a direction parallel to the longitudinal, rotational axis (7) of the drum (3) and each collar (9) extending transverse to the longitudinal axis (7) of the drum (3); a cutting tooth mounting block (27) fixedly mounted to, and extending between, each pair of adjacent collars (9), the mounting block (27) located at the outer, peripheral portion of the collars (9) and spaced well above the surface (5) of the drum (3) to provide a substantial gap (45) between the mounting block (27) and the drum (3) for use in dispersing chips and other material cut by the rotary cutter during its operation, each block (27) adapted to detachably mount a cutting tooth (55) with the cutting edge of the tooth located in front of the block (27) and above the outer edge (13) of the collars (9).

2. A cutter as claimed in claim 1 wherein the longest length of an imaginary straight line passing through the center of each collar (9) between opposed sides of the outer edge (13) of the collar (9) is about twice the diameter of the drum (3).

3. A cutter as claimed in claim 1 wherein both the inner (11) and outer (13) edges of the collar (9) are circular.

4. A cutter as claimed in claim 3 wherein the diameter of the outer edge (13) is about twice the diameter of the inner edge (11).

5. A cutter as claimed in claim 1 wherein each collar (9) of each pair has a first cut-out (15) extending inwardly from the outer edge (13) of the collar (9) just in front of the mounting block (27) to aid in chip dispersal.

6. A cutter as claimed in claim 5 including a second smaller cut-out (46) extending inwardly from the outer edge (13) just behind the first cut-out (15), the second cut-out (46) providing support with a trailing edge (51) for at least a portion of the mounting block (27) to butt against.

7. A cutter as claimed in claim 5 including a second larger cut-out (117) extending inwardly from the outer edge (113) just behind the first cut-out (115), the second cut-out (117) providing support for the rear portion of the mounting block (127) to butt against.

8. A cutter as claimed in claim 1 wherein the cutting tooth (55) has a cutting portion (57) extending generally tangentially, to a radius line extending from the longitudinal axis of the drum, from the front (33) of the mounting block (27), the cutting portion (57) terminating in the cutting edge (73).

9. A cutter as claimed in claim 1 wherein at least a portion (13a) of the outer edge (13) of the collars (9) is a helical shape approaching the rear of the mounting block (27) to gradually increase the outer radius of the collars (9) to a maximum (R1) at the mounting block (27), the outer radius (r1) of the outer edge (13a) of the collars (9) at the front of the mounting block (27) being a minimum.

10. A cutter as claimed in claim 2 wherein at least a portion (13a) of the outer edge (13) of the collars (9) is a helical shape approaching the rear of the mounting block (27) to gradually increase the outer radius of the collars (9) to a maximum (R1) at the mounting block (27), the outer radius (r1) of the outer edge (13a) of the collars (9) at the front of the mounting block (27) being a minimum.

11. A cutter as claimed in claim 5 wherein the mounting block (27) has lateral extending arms (47) at the front of the block for resting on the edge of the second cut-outs (46) and abutting against the trailing edge (51) of the cut-outs (46).

12. A cutter as claimed in claim 1 wherein a major portion of the mounting block (27) is below the outer edge (13) of the collars (9).

13. A cutter as claimed in claim 1 wherein each collar (9), except for the first and last collars, has one mounting block (27) on one side of the collar and another mounting block (27) on the other side of the collar, the blocks circumferentially spaced-apart.

14. A cutter as claimed in claim 1 wherein the cutting tooth (55) has a cutting portion (59) extending forwardly from the mounting block (27), the cutting portion (59) terminating in the cutting edge (73), the cutting portion (59) slightly curved to have its top surface (63) generally lie on the imaginary circle generated by the cutting edge (73) on rotation of the drum (3).

15. A cutter as claimed in claim 1 wherein each collar (9) of the said pair of collars has another mounting block (27) attached to its other side from the side the first mounting block (27) is attached, the other mounting block (27) on one collar (9) of said pair of collars circumferentially offset from the first mounting block in one direction and the other mounting block on the other collar of said pair of collars circumferentially offset from the first mounting block in the opposite direction to the one direction.

16. A rotary cutter having a rotatable cylindrical drum (3); a plurality of collars (9) fixedly mounted on the surface (5) of the drum (3), the collars equally spaced apart and extending transverse to the axis (7) of rotation of the drum (3); each adjacent pair of collars having two opposed mounting blocks (27) mounted on, and between, the collars on the upper peripheral portion of the collars, each collar of each pair of adjacent collars having two additional opposed mounting blocks (27) mounted on, and between, it and another adjacent collar, the two additional opposed mounting blocks circumferentially offset from the first two mounting blocks, the two additional blocks on one of the pair of collars circumferentially offset in one direction from the first blocks and the two additional blocks on the other of the pair of collars circumferentially offset in the opposite direction to the one direction from the first blocks.
